(19) United States
(12) Patent Application Publication
(10) Pub. No.: US 2012/0192288 A1
(43) Pub. Date: Jul. 26, 2012

(54) ELECTRONIC DEVICE WITH FUNCTION OF SECURING DIGITAL FILES AND METHOD THEREOF

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/152,296

(22) Filed: Jun. 3, 2011

(30) Foreign Application Priority Data
Jan. 24, 2011 (CN) 201110025746.4

(51) Int. Cl. G06F 21/24; G06F 7/04

(52) U.S. Cl. 726/28

(57) ABSTRACT

An electronic device with a function of securing digital files which includes a number of input units, a storage unit, a display unit and a processing unit. Each of the input units is assigned an identifier. The storage unit stores a predetermined identifier and a predetermined password. The processing unit includes an input unit determining module, an acquiring module, an identifier determining module, a prompt window generating module, a password determining module and a performing module. The input unit determining module determines which input unit is utilized. The acquiring module acquires the identifier of the determined input unit. The identifier determining module determines whether the acquired identifier matches the predetermined identifier. The prompt window generating module generates a prompt window. The password determining module determines whether the password input matches the predetermined password. The performing module opens the required file if the password input matches the predetermined password.

### BACKGROUND

1. Technical Field

The present disclosure relates to electronic devices and, particularly, to an electronic device with the ability to store digital files in a secure manner and a method thereof.

2. Description of Related Art

Important digital files are usually stored in electronic devices, such as notebooks, mobile phones, etc. In order to prevent the digital file from being stolen or publicly divulged, users often set a password in the electronic devices and needs to input the password when attempting to access these digital files. However, because the password itself can be stolen, the conventional way of password protection is not enough to prevent unauthorized access.

Therefore, what is needed is an electronic device with a function of storing digital files in a secure manner to overcome the described limitations.

### BRIEF DESCRIPTION OF THE DRAWINGS

FIG. 1 is a block diagram of the hardware infrastructure of an electronic device capable of storing digital files securely, in accordance with an exemplary embodiment.

FIG. 2 shows a number of input units being displayed on a display unit of the electronic device of FIG. 1.

FIG. 3 shows a prompt window being displayed on the display unit.

FIG. 4 is a flowchart of a method for securing digital files implemented by the electronic device of FIG. 1, in accordance with an exemplary embodiment.

### DETAILED DESCRIPTION

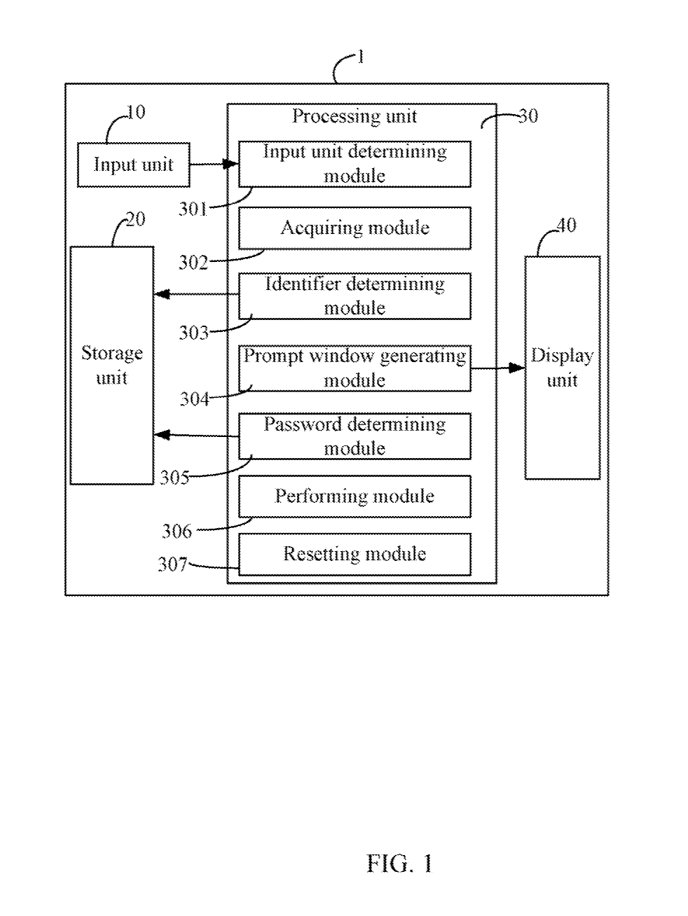

FIGS. 1-3 show an electronic device 1 with a function of securing digital files.

The electronic device 1 includes a number of input units 10 (only one is shown), a storage unit 20, a display unit 40, and a processing unit 30. Each input unit 10 is configured to receive user input. An identifier is assigned to each input unit 10. In one embodiment, the input units 10 may be touch screens or may be keyboards etc.

The storage unit 20 is configured to store a predetermined identifier and a predetermined password. The predetermined identifier is one of the identifiers assigned to the input units 10. In one embodiment, the predetermined password may be characters or numbers, or a combination of characters and numbers.

The processing unit 30 includes an input unit determining module 301, an acquiring module 302, an identifier determining module 303, a prompt window generating module 304, a password determining module 305, and a performing module 306.

The input unit determining module 301 is configured to determine which input unit 10 has been utilized when receiving a user input.

The acquiring module 302 is configured to acquire the identifier of the determined input unit 10.

The identifier determining module 303 is configured to determine whether the acquired identifier matches the predetermined identifier stored in the storage unit 20.

The prompt window generating module 304 is configured to generate a prompt window on the display unit 40 for prompting the user to input a password when the acquired identifier matches the predetermined identifier stored in the storage unit 20.

In one embodiment, the prompt window generating module 304 does not generate any prompt window when the acquired identifier does not match the predetermined identifier stored in the storage unit 20.

The password determining module 305 is configured to determine whether the password input in the prompt window matches the predetermined password stored in the storage unit 20. In one embodiment, the password determining module 305 further generates an error signal to prompt that the password is wrong when the password input in the prompt window does not match the predetermined password stored in the storage unit 20.

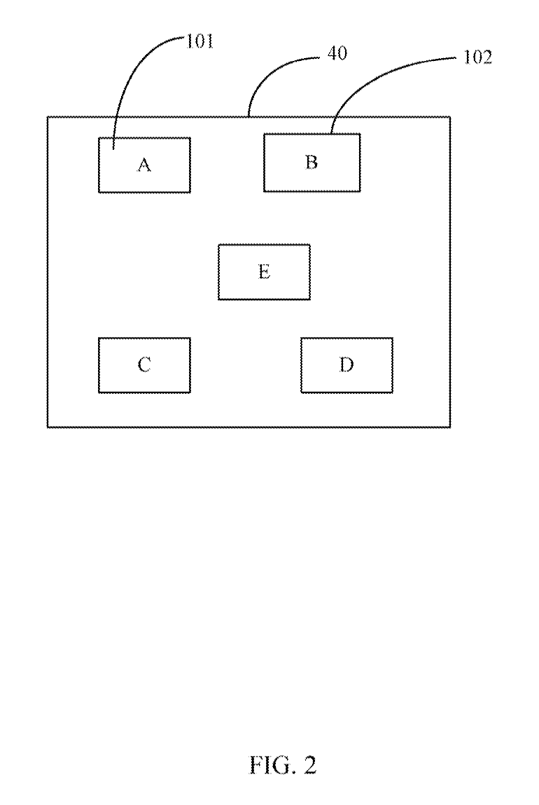

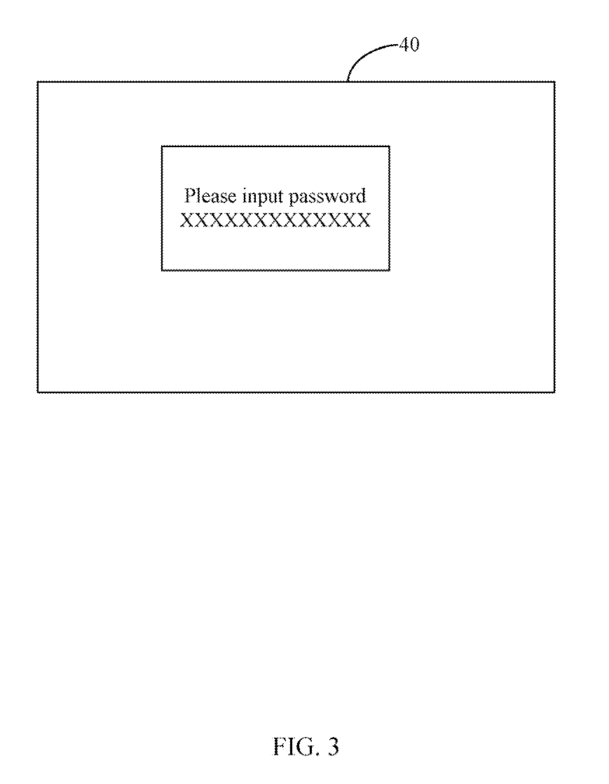

The performing module 306 is configured to open a corresponding file protected by the predetermined password when the password input in the prompt window matches the predetermined password. As shown in FIG. 2, five input units 10 are displayed on the display unit 40, the predetermined identifier stored in the storage unit 20 is the identifier assigned to the input unit 102. If the user touches the input unit 101, the prompt window generating module 304 does not generate any prompt window, but if the user touches the input unit 102, the prompt window generating module 304 will generate a prompt window (as shown in FIG. 3) to prompt the user to input a password. Therefore, by utilizing a protection mechanism which requires that the correct input unit 10 should be selected on the first attempt and further that the password should be input correctly, the possibility of illegal access to digital files stored in the electronic device 1 is reduced.

In another embodiment, the processing unit 30 further includes a resetting module 307 which can be programmed by an authorized user to reset the predetermined identifier and/or the predetermined password stored in the storage unit 20.

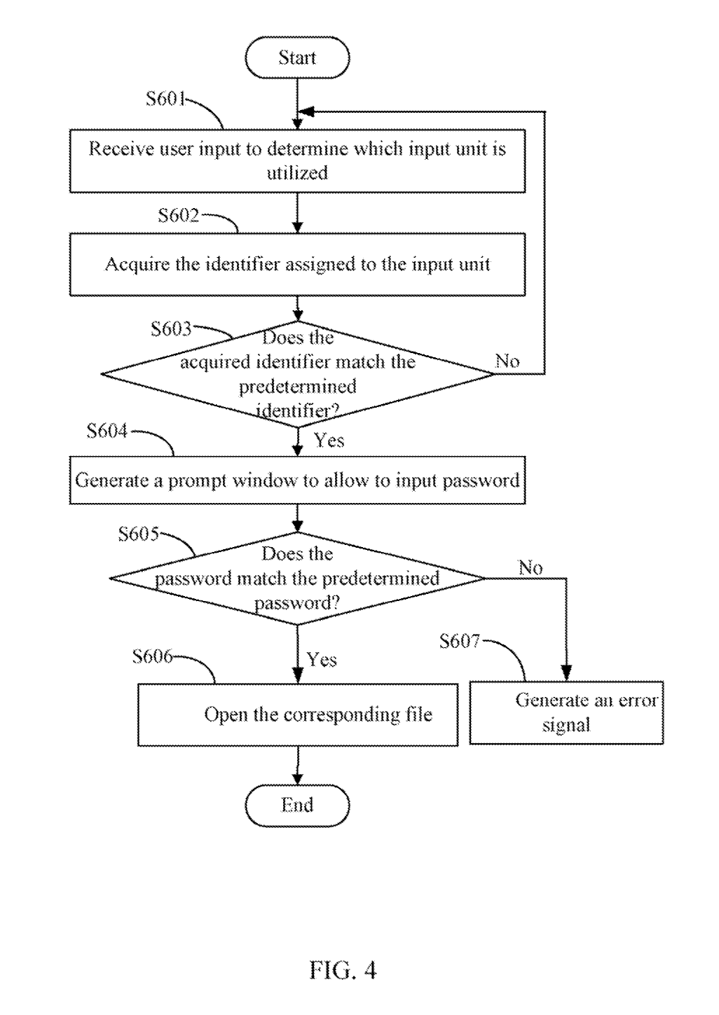

FIG. 4 is a flowchart of a method for securing digital files implemented by the electronic device 1 of FIG. 1, in accordance with exemplary embodiment.

In step S601, the input unit determining module 301 determines which input unit 10 has been utilized when receiving a user input.

In step S602, the acquiring module 302 acquires the identifier of the determined input unit 10.

In step S603, the identifier determining module 303 determines whether the acquired identifier matches the predetermined identifier stored in the storage unit 20, if yes, the procedure goes to step S604, if no, the procedure goes to step S601.

In step S604, the prompt window generating module 304 generates the prompt window on the display unit 40 to allow to input password.

In step S605, the password determining module 305 determines whether the password input in the prompt window matches the predetermined password stored in the storage unit 20, if yes, the procedure goes to step S606, if no, the procedure goes to step S607.

In step S606, the performing module 306 opens the corresponding file.

In step S607, the password determining module 305 generates an error signal if the entered password input is wrong.

In another embodiment, the method further includes a step whereby the resetting module 307 resets the predetermined identifier and/or the predetermined password stored in the storage unit 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with a function of securing digital files, comprising:
a plurality of input units configured to receive user input, wherein each of the input units is assigned an identifier;
a display unit;
a storage unit configured to store a predetermined identifier and a predetermined password, wherein the predetermined identifier is one of the identifiers assigned to the input units; and
a processing unit comprising:
an input unit determining module configured to determine which input unit is utilized when receiving a user input;
an acquiring module configured to acquire the identifier of the determined input unit;
an identifier determining module configured to determine whether the acquired identifier matches the predetermined identifier stored in the storage unit;
a prompt window generating module configured to generate a prompt window on the display unit to allow to input a password when the acquired identifier matches the predetermined identifier stored in the storage unit;
a password determining module configured to determine whether the password input in the prompt window matches the predetermined password stored in the storage unit; and
a performing module configured to open a corresponding file protected by the predetermined password when the password input in the prompt window matches the predetermined password.

2. The electronic device as described in claim 1, wherein the processing unit further comprises a resetting module configured to reset the predetermined identifier and/or the predetermined password stored in the storage unit.

3. The electronic device as described in claim 1, wherein the predetermined password is characters or numbers.

4. The electronic device as described in claim 1, wherein the predetermined password is a combination of characters and numbers.

5. The electronic device as described in claim 1, wherein the password determining module is further configured to generate an error signal to indicate that the password input is wrong when the password input does not match the predetermined password stored in storage unit.

6. A method for securing digital files implemented by an electronic device, wherein the electronic device comprises a plurality of input units, a display unit and a storage unit, each of the input units is configured to receive user input, and is assigned an identifier; the storage unit stores a predetermined identifier and a predetermined password, the predetermined identifier is one of the identifiers assigned to the input units, the method comprising:
determining which input unit is utilized when receiving a user input;
acquiring the identifier of the determined input unit;
determining whether the acquired identifier matches the predetermined identifier stored in the storage unit;
generating a prompt window on the display unit to allow to input a password when the acquired identifier matches the predetermined identifier stored in the storage unit;
determining whether the password input in the prompt window matches the predetermined password stored in the storage unit; and
opening a corresponding file protected by the predetermined password when the password input in the prompt window matches the predetermined password.

7. The method as described in claim 6, further comprising:
resetting the predetermined identifier and/or the predetermined password stored in the storage unit.

8. The method as described in claim 6, further comprising:
generating an error signal to indicate that the password input is wrong when the password input does not match the predetermined identifier.
